(19) United States
(12) Patent Application Publication
(10) Pub. No.: US 2026/0340909 A1
(43) Pub. Date: Oct. 29, 2026

(54) NATURAL LANGUAGE-BASED TECHNOLOGIES FOR EMBEDDING SPECIFIED CONTENT INTO REAL-TIME ACTIVITY

(71) Applicants: Roger Kim, Austin, TX (US); Antonio Llongueras, Austin, TX (US)

(72) Inventors: Roger Kim, Austin, TX (US); Antonio Llongueras, Austin, TX (US)

(21) Appl. No.: 19/658,169

(22) Filed: Apr. 24, 2026

Related U.S. Application Data
(60) Provisional application No. 63/794,962, filed on Apr. 25, 2025.

(51) Int. Cl. G06T 11/60; G06F 40/149; G06F 40/284; G06F 40/30; G06Q 30/0241

(52) U.S. Cl. CPC G06T 11/60; G06F 40/149; G06F 40/284; G06F 40/30; G06Q 30/0276

(57) ABSTRACT

Techniques are disclosed for rendering sponsored content within a streaming natural-language output. A system receives, from a generative language model, a streaming sequence of natural-language tokens that includes first and second zero-width control tokens marking boundaries of a sponsored segment. An offset map is constructed in real time to specify indices delimiting the sponsored segment within the token stream. The natural-language tokens are rendered while programmatically applying a visual treatment to the sponsored segment based on the offset map, without altering token order or requiring post-generation rewriting. A disclosure label is presented adjacent to the sponsored segment, the disclosure label having a luminance-contrast ratio relative to non-sponsored text.

### CROSS-REFERENCE TO RELATED APPLICATIONS

This application claims the benefit of U.S. Provisional Application No. 63/794,962, filed Apr. 25, 2025, the entirety of which is incorporated herein.

### FIELD

The present disclosure generally relates to content generation systems and more specifically to technical improvements in integrating supplemental content into streaming natural language outputs for rendering to a display to deliver contextually relevant recommendations in response to a real-time context and/or interaction.

### BACKGROUND

Modern computing systems increasingly rely on generative language models and other machine learning systems to generate natural language outputs in response to user inputs. Such systems may be deployed across a wide range of computing environments, such as web browsers, mobile applications, messaging platforms, and voice-driven interfaces. Such computing environments may generate and deliver responses as streaming sequences of tokens. An example of systems that adopt such approaches are digital advertising platforms (e.g., affiliate marketing systems which help businesses promote their products or services online and a business to connect with audiences using data-driven methods to deliver advertising and other sponsored content). For example, affiliate marketing systems embed affiliate links for a product or service into a given context (e.g., a website, mobile application). When a user clicks on the link and purchases the product or service (i.e., converts the affiliate link into a sale), the affiliate receives a commission on the sale.

A technical challenge arises when attempting to incorporate supplemental content, such as sponsored content, regulated disclosures, or contextually relevant data, directly into output generated by such computing environments. Conventional approaches for incorporating such content typically rely on post-processing techniques, such as by modifying generated text after completion to insert additional content or by rendering separate user interface elements independently from the generated output. However, such conventional approaches potentially disrupt token alignment and may corrupt intermediate representations used by rendering engines (e.g., such as in streaming environments in which tokens are incrementally emitted and consumed). Further, such approaches can introduce latency by requiring buffering and reprocessing generated output prior to rendering on a display. Further still, using separate user interface elements that render supplemental content outside of generated output can disrupt coherence of the output stream and require additional synchronization between independent rendering layers.

Continuing the example of digital advertising platforms, traditional integrations typically rely on static methods, such as manually embedding pre-selected affiliate links (or other sponsored content such as digital advertisements) into content, webpages, or applications. In addition to the drawbacks discussed above, such approaches are also prone to human error and result in generic or loosely relevant recommendations due to the inherent difficulty in consistently matching dynamic user interests, context, and interactions. Further, although existing affiliate marketing technologies integrate automated solutions, such solutions often depend on simplistic rule-based or keyword-matching systems, which lack sophistication to understand nuanced user context, rapidly evolving user interests, or complex interaction histories. As a result, recommendations provided by these systems can easily result in outdated information, lacking in relevance and timeliness and ultimately reducing user engagement, reduced conversion rates, and diminished potential for marketers and application owners.

### SUMMARY

Embodiments presented herein disclose a computer-implemented method. The method generally includes receiving, from a client device, a natural language input. The method also generally includes determining, using a machine-learning based model, whether the natural language input is indicative of a commercial intent. Upon a determination that the natural language input is indicative of the commercial intent, a context vector representation of the natural language input is generated using the machine-learning based model, and one or more ad objects based on a similarity search are identified using the context vector representation over a semantic advertisement index. A streaming sequence of tokens representing a natural language response is generated. During the generation of the streaming sequence of tokens, a first control token and a second control token delimiting a segment corresponding to at least one of the ad objects is inserted, and tokens corresponding to the at least one ad object between the first and second control tokens are emitted. The streaming sequence of tokens is transmitted to the client device for display thereon.

Another embodiment presented herein discloses another computer-implemented method. The method generally includes receiving, from a generative language model, a streaming sequence of natural-language tokens that includes a first zero-width control token and a second zero-width control token marking respective boundaries of a sponsored segment. The method also includes constructing, in real time, an offset map specifying indices delimiting the sponsored segment, and causing a client device to render the natural-language tokens while programmatically applying a visual treatment to the sponsored segment based on the offset map. The method also includes causing the client device to present, adjacent to the sponsored segment, a disclosure label having a luminance-contrast ratio relative to non-sponsored text.

Yet another embodiment presented herein discloses a system that includes one or more processors and a memory storing instructions that, when executed, cause the system to receive a natural language input from a client device, determine whether the natural language input is indicative of a commercial intent, generate a context vector representation of the natural language input, and identify one or more ad objects based on a similarity search over a semantic advertisement index. The system is further configured to generate a streaming sequence of tokens representing a natural language response, insert control tokens delimiting a segment corresponding to at least one ad object during generation of the streaming sequence of tokens, emit tokens corresponding to the at least one ad object, and transmit the streaming sequence of tokens to the client device for display.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 illustrates a conceptual diagram of a computing environment in which artificial intelligence (AI)-based agents are deployed to dynamically retrieve contextually relevant recommendations based on user interactions and real-time contexts, according to an embodiment;

FIG. 2 illustrates a block diagram of components for a computing system of the computing environment described relative to FIG. 1;

FIG. 3 illustrates a block diagram of components of a server application executing a Model Context Protocol (MCP), according to an embodiment;

FIG. 4 illustrates a block diagram of components of an AI agent application, according to an embodiment;

FIG. 5 illustrates a flow diagram of a method for delivering contextually relevant recommendations in response to a real-time context and/or interaction, according to an embodiment;

FIG. 6 illustrates a flow diagram of a method for dynamically retrieving semantic content in response to a user input, according to an embodiment;

FIG. 7 illustrates a sequence diagram for delivering contextually relevant recommendations in response to a real-time context and/or interaction, according to an embodiment; and

FIGS. 8A and 8B illustrate an example of delivering contextually relevant recommendations in response to a user interaction with an AI chatbot application, according to an embodiment.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

Existing computing environments which generate natural language outputs in response to user inputs through generative language models (and other machine learning systems), such as digital advertisement platforms, can potentially disrupt operation of a computing system and increase latency of the underlying system due to buffering and reprocessing. Further, digital advertisement platforms trigger advertisements using keyword rules or post-processing generated text, which lacks deep semantic understanding of user inputs and context, perform poorly in conversational settings, and often require model-specific integrations. In addition, known “sponsored answer” chatbots render ads either as separate user interface (UI) blocks (which break conversational flow) or undisclosed inline text (which introduces regulatory risk).

Embodiments presented herein disclose artificial intelligence (AI) and machine learning (ML)-based improvements to generating and rendering digital content in computing environments in which outputs are produced and delivered as streaming sequences of tokens (e.g., digital advertising platforms). In such environments, tokens are incrementally generated by a model and transmitted to a downstream component for rendering, often prior to completion of the full output. The disclosed improvements enhance the operation of such systems by enabling selective modification of portions of the generated output without disrupting the underlying token stream or requiring post-generation rewriting.

As described further herein, the disclosed improvements integrate AI agents with digital advertising systems (e.g., affiliate marketing systems, search engine optimization platforms, display advertising platforms, etc.) to dynamically retrieve contextually relevant product or service recommendations aligned precisely with user interactions and real-time context. The disclosed improvements also use AI/ML-based techniques such as natural language processing (NLP) to infer advertisement opportunities from user inputs (e.g., text-based communications, social media activity, interactions with a user device) and deliver the product or service recommendations seamlessly in a natural language format that also complies with advertising regulations.

In some embodiments, the disclosed improvements leverage a standardized JSON-RPC 2.0-based communication protocol, supporting various transport methods, such as Standard Input/Output (stdio) for local interactions and Server-Sent Events (SSE) for remote real-time integrations. The communication protocol ensures structured and efficient communication using defined message types, including requests, responses, and notifications. Doing so enables robust and stateful connections between clients and servers.

In some embodiments, the AI agents incorporate NLP-based technologies, such as large language models (LLMs), to convert rich conversational context into a high-dimensional embedding, search a purpose-built advertisement index, and return structured ad objects including information such as compliance metadata and payout terms though a transport-agnostic service interface. In an embodiment, the ad object is a data structure that includes information such as an identifier, a text string (e.g., indicative of ad content), an associated landing URL, an embedding position, a compliance indicator, and a payout schema.

Advantageously, the disclosed technological improvements enhance computational efficiency, contextual accuracy, and responsiveness of integrated recommendations by automating intelligent context-matching processes over prior approaches. For instance, protocol portability (e.g., stdio, SSE, WebSocket, and so on) ensures that the software stack is usable in a variety of environments, including embedded, mobile, and serverless environments. In addition, the use of an immutable ledger in tracking revenue and compliance improves revenue-share trust between model owners, ad networks, and publishers. In addition, the use of token-boundary disclosure as further described herein ensures that the disclosed technology meets emerging EU and US generative AI transparency rules without satisfying UX quality. The disclosed improvements further enhance the operation of computing systems that generate and render machine-produced outputs by preserving integrity of streaming token sequences, reducing latency associated with post-generation manipulation, enabling selective and deterministic transformation of output segments using positional mappings, and supporting consistent integration of supplemental content across heterogeneous computing environments.

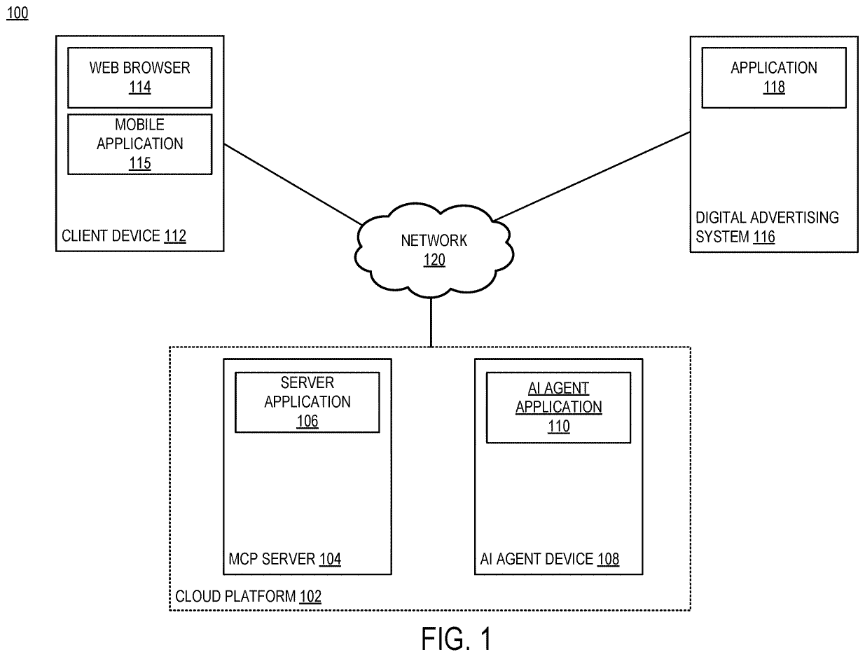

Referring now to FIG. 1, a computing environment 100 for dynamically delivering contextually relevant product or service recommendations aligned with user interactions and real-time contexts includes a cloud platform 102, client device 112, and digital advertising system 116, each connected to a network 120 (e.g., the Internet).

The cloud platform 102 provides a distributed computing environment configured to support generation, processing, retrieval, and rendering of machine-generated content in real time. In particular, the cloud platform 102 is configured to coordinate interactions between generation components, control components, retrieval services, and rendering-support services to enable selective modification of streaming token sequences without disrupting token alignment or requiring post-generation rewriting. In an embodiment, the cloud platform 102 includes one or more compute nodes executing containerized or virtualized workloads. The compute nodes may be orchestrated using a container orchestration system, such as a cluster manager, to dynamically allocate resources based on workload demands. For example, generation workloads associated with machine learning models may be deployed on compute nodes having hardware acceleration (e.g., GPUs, TPUs), while retrieval and protocol-handling workloads may be deployed on general-purpose compute nodes. Generally, the cloud platform 102 provides computing resources over the network 120 to enable the scalable development, deployment, and management of applications or services.

In some embodiments, the cloud platform 102 includes a protocol interface layer configured to support communication across multiple transport mechanisms. For example, the protocol interface layer may support communication using one or more of JSON-RPC, RESTful HTTP, WebSocket, Server-Sent Events (SSE), or other messaging protocols. The protocol interface layer may normalize requests and responses into a common schema, thereby enabling interoperability between heterogeneous components and clients. In an embodiment, the cloud platform 102 includes a streaming gateway configured to transmit token sequences and associated metadata to one or more client devices. The streaming gateway may support low-latency delivery of tokens as the tokens are generated and may selectively filter or transform control tokens prior to transmission. In some embodiments, the streaming gateway transmits the token sequence and metadata via separate channels to maintain separation between user-visible content and control data.

In an embodiment, the cloud platform 102 includes a Model Context Protocol (MCP) server 104 and an AI agent device 108. Although FIG. 1 depicts a single MCP server 104 and AI agent device 108, in practice multiple MCP servers 104 and AI agent devices 108 may execute to perform the functions described herein.

As further described herein, the MCP server 104 provides a server application 106 processes structured requests (e.g., via an application programming interface (API) exposed to systems such as the AI agent device 108) to serve personalized and trackable digital advertisements to the requestor. The server application 106 may further manage revenue sharing between affiliates, businesses, and other entities.

The AI agent device 108 is configured to process user inputs, generate machine-produced outputs, and coordinate insertion and rendering of supplemental content within streaming token sequences. The AI agent device 108 may be embodied as a standalone computing system, a distributed service executing within the cloud platform 102, or a hybrid system in which portions of functionality execute on a client device 112 and portions execute remotely.

In an embodiment, the AI agent device 108 may execute an AI agent application 110. The AI agent application 110 is configured to process inputs, generate streaming outputs, and coordinate insertion and rendering of supplemental content within those outputs. The AI agent application 110 may be in communication (e.g., such as a web browser 114 executing on the client device 112, a mobile application 115) to receive inputs such as text and audio inputs from a user and generate suggestions and content based on the inputs. To do so, the AI agent device 108 may execute one or more AI/ML-based models to process such inputs and generate such suggestions and content. For example, as further described herein, the AI agent device 108 may execute a large language model (LLM) to understand natural language inputs provided by the user to further determine whether generation of digital advertisements based on the inputs should occur. The AI/ML-based models may also be used to create natural language responses that incorporate the digital advertisements.

One of skill in the art will recognize that the components of the cloud platform 102 may be distributed across multiple physical or virtual systems and communicate via one or more networks. In some embodiments, one or more components may be co-located or integrated into a single system. Additionally, functionality attributed to a given subsystem may be partitioned, combined, or reconfigured without departing from the scope of the present disclosure.

The client device 112 may be embodied as any physical or virtual computing device (e.g., a mobile phone, tablet, personal computer, Internet-of-Things device, wearable, etc.) of a user to which dynamically generated digital advertisements (e.g., affiliate links, text-based ads, image ads, etc.) are served. For example, the user may access websites via the web browser 114 that provide opportunities for user input to be shared (e.g., through form boxes, interactions observed using sensors of the client device 112, chat windows, etc.). The mobile application 115 may be embodied as any software application executing on the client device 112 that can be integrated with the AI agent application 110. For example, the mobile application 115 may be an ecommerce app that provides virtual shopping assistant services that observe user behavior (e.g., via chat programs, via user behavior with the app as captured by sensors of the client device 112, via user searches, etc.), in which the AI agent application 110 may process the observed user behavior to deliver recommendations. As another example, the mobile application 115 may be a messaging program that enables users to communicate with users and chatbots, in which the AI agent application 110 may process transmitted user inputs to deliver recommendations. As yet another example, the mobile application 115 may be a smart assistant application that processes user voice inputs to deliver recommendations.

The digital advertisement system 116 provides a digital marketing infrastructure for delivering ad content to a client device 112 to cause the client device 112 to display the ad content. To do so, the digital advertisement system 116 may include an application 118 that provides a frontend interface (e.g., to allow an affiliate to register, obtain tracking links, obtain advertising content, view performance, request payouts, etc.), a backend interface (e.g., to handle user data, advertising content, commissions, tracking), and a tracking mechanism (e.g., to track affiliate links and ad content, user cookies, sales conversions, etc.). In an embodiment, the digital advertisement system 116 is integrated with the MCP server 104 and AI agent device 108 to deliver digital ad suggestions and recommendations. In some embodiments, the digital advertising system 116 is an affiliate marketing system configured to embed affiliate links associated with a product or service into content (e.g., a website, app, chat interface, etc.).

Although FIG. 1 depicts systems such as the MCP server 104 and AI agent device 108 as executing in a cloud platform, such systems and/or underlying components may reside at least in part on the client device 112, web-based platforms, dedicated on-premises hardware, and the like. For example, the AI agent application 110 may execute on the client device 112 in integration with the web browser 114 and/or mobile application 115. In other implementations, the mobile application 115 may incorporate components of the AI agent application 110 therein to perform the functions of the present disclosure.

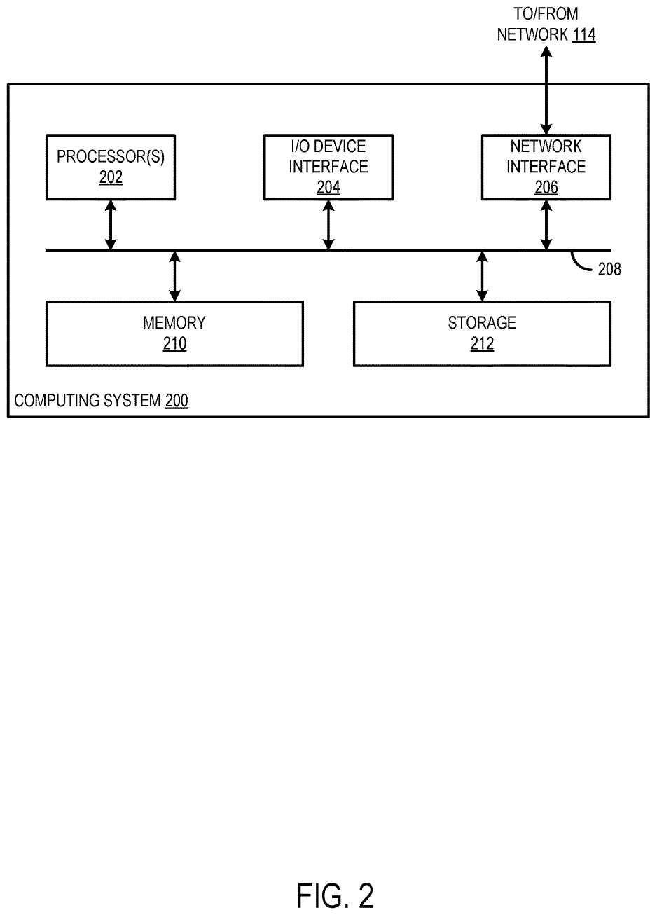

Referring now to FIG. 2, a block diagram illustrating hardware components of an example computing system 200 (e.g., client device 112, digital advertising system 116, MCP server 104, AI agent device, etc.). As shown, computing system 200 includes, without limitation, a one or more processors 202, an input/output (I/O) device interface 204, a network interface 206, a memory 210, and a storage 212, each interconnected via a hardware bus 208. Of course, the actual computing system 200 will include a variety of additional hardware components not shown. Additionally, in some embodiments, one or more of the illustrative components may be incorporated in, or otherwise form a portion of, another component.

The processors 202 retrieve and execute programming instructions stored in the memory 210. The processors 202 may be embodied as one or more processors, each processor being a type capable of performing the functions described herein. For example, the processors 202 may be embodied as a single or multi-core processor(s), a microcontroller, or other processor or processing/controlling circuit. In some embodiments, the processors 202 may be embodied as, include, or be coupled to a field programmable gate array (FPGA), an application-specific integrated circuit (ASIC), reconfigurable hardware or hardware circuitry, or other specialized hardware to facilitate performance of the functions described herein. The hardware bus 208 is used to transmit instructions and data between the processors 202, storage 212, network interface 206, and the memory 210. The processors 202 are included to be representative of a single CPU, multiple CPUs, a single CPU having multiple processing cores, a graphical processing unit (GPU), a combination of CPUs and GPUs, and the like.

The memory 210 may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

The network interface 206 may be embodied as any hardware, software, or circuitry (e.g., a network interface card) used to connect the computing system 200 over the network 122 and providing the network communication component functions described above. For example, the network interface 206 may be embodied as any communication circuit, device, or collection thereof, capable of enabling communications over the network 122 between the computing system 200 and other devices. The network interface 206 may be configured to use any one or more communication technology (e.g., wired, wireless, and/or cellular communications) and associated protocols (e.g., Ethernet, Bluetooth®, Wi-Fi®, WiMAX, 5G-based protocols, etc.) to effect such communication. For example, to do so, the network interface 206 may include a network interface controller (NIC, not shown), embodied as one or more add-in-boards, daughtercards, controller chips, chipsets, or other devices that may be used by the computing system 200 for network communications with remote devices. For example, the NIC may be embodied as an expansion card coupled to the I/O device interface 204 over an expansion bus such as PCI Express.

The I/O device interface 204 allows I/O devices to communicate with hardware and software components of the computing system 200. For example, the I/O device interface 204 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O device interface 204 may form a portion of a system-on-a-chip (SoC) and be incorporated, along with one or more of the processors 202, the memory 210, and other components of the computing system 200. The I/O devices may be embodied as any type of I/O device connected with or provided as a component to the computing system 200. I/O devices such as keyboards, mice, and printers may be included as I/O devices.

The storage 212 may be embodied as any type of device configured for short-term or long-term storage of data such as, for example, memory devices and circuits, memory cards, hard disk drives (HDDs), solid-state drives (SSDs), or other data storage devices. The storage 212 may include a system partition that stores data and firmware code for the storage 212. The storage 212 may also include an operating system partition that stores data files and executables for an operating system.

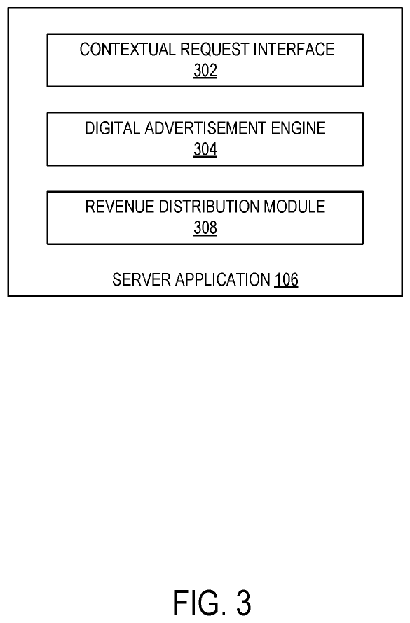

Referring now to FIG. 3, a block diagram depicting components of the server application 106 of the MCP server 104 includes a contextual request interface 302, a digital advertisement engine 304, and a revenue distribution module 308.

The contextual request interface 302 may be embodied as any hardware, software, and/or circuitry configured to provide an interface (e.g., a standardized API) for formatting requests to the MCP server 104. The contextual request interface 302 may be further configured to generate, normalize, and transmit structured requests representing contextual information derived from one or more inputs. In an embodiment, the contextual request interface 302 operates as an intermediary layer between the AI agent application 110 and the MCP server 104, transforming unstructured or semi-structured input data into a machine-readable request format suitable for downstream processing. For example, the interface may enable the AI agent application 110 to formulate and send structured requests having detailed context data such as user preferences, interaction history, product category data, and price range data.

The digital advertisement engine 304 may be embodied as any hardware, software, and/or circuitry to process structured requests and generate one or more content objects responsive to contextual information. In an embodiment, the digital advertisement engine 304 operates as a processing pipeline that transforms a structured request, including a context representation, into a set of candidate content objects that are suitable for integration into a generated output. The digital advertisement engine 304 may further be configured to dynamically cross-reference a user context with product databases and owner-affiliate data. Further, the digital advertisement engine 304 may return a personalized and trackable link. The digital advertisement engine 304 uniquely optimizes recommendations based on both general product relevance and specific owner-affiliate relationships. The dual-layered contextual matching and balancing general product affinity with individualized affiliate relationships is a distinctive improvement that traditional marketing systems do not offer.

The revenue distribution module 308 may be embodied as any hardware, software, and/or circuitry to process event data associated with interactions and to generate allocation records based on the processed data. For instance, the revenue distribution module 308 may do so to implement precise, automated attribution of conversions to specific interactions (e.g., with a given AI agent application 108 instance) to ensure transparent management of revenue sharing among stakeholders. In an embodiment, the revenue distribution module 308 operates as a data processing subsystem that correlates interaction events with contextual identifiers and computes allocation outputs using structured data representations.

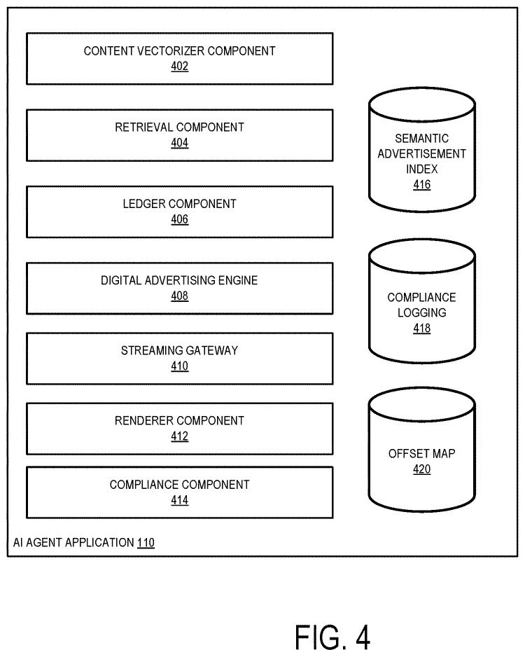

Referring now to FIG. 4, a conceptual block diagram of components of the AI agent application 110 is shown. Illustratively, the AI agent application 110 includes a content vectorizer component 402, a retrieval component 404, a ledger component 406, a digital advertising engine 408, a streaming gateway 410, a renderer component 412, a compliance component 414, a semantic advertisement index 416, compliance logging 418, and an offset map 420.

The content vectorizer component 402 may be embodied as any hardware, software, and/or circuitry configured to transform input data into one or more structured representations suitable for downstream processing. In an embodiment, the content vectorizer component 402 operates as a transformation pipeline that converts unstructured or semi-structured inputs into vector-based representations while preserving contextual information associated with the inputs. For example, the content vectorizer component 402 may receive a string corresponding to a user input (e.g., a text message, a voice input converted to a text string, etc.). The content vectorizer component 402 may convert the input (including any associated user data such as a conversation history, user profile, etc.) into a vector embedding. The embedding represents a conversation context.

The retrieval component 404 may be embodied as any hardware, software, and/or circuitry configured to identify and return one or more content objects based on a structured representation of an input. In an embodiment, the retrieval component 404 operates as a query processing pipeline that transforms a context representation into a set of candidate content objects using one or more search techniques over one or more data structures. To do so, the retrieval component 404 may provide an API exposing uniform endpoints over multiple transports (e.g., MCP, JSON-RPC, REST HTTPS, gRPC, etc.). The API allows any LLM or orchestration framework to invoke retrieval functions without necessitating custom code.

The ledger component 406 may be embodied as any hardware, software, and/or circuitry configured to record, maintain, and provide access to structured records associated with processing performed by the system. For instance, the ledger component 406 may generate and store an immutable record corresponding to a pairing of a semantic query (e.g., a processed user input) and a downstream conversion. A given ledger entry may include information such as a query hash value, advertisement identifier, a client timestamp, a conversion timestamp, and a payout schema. In an embodiment, the ledger component 406 operates as a persistent data subsystem that stores records corresponding to associations between inputs, generated outputs, and interaction events to enable traceability and verification of system operations. In some embodiments, the ledger component 406 may be a blockchain ledger or some other immutable ledger.

The semantic advertisement index 416 may be embodied as a database, such as a vector or a graph database, configured to store and organize representations of content objects in a manner that supports efficient similarity-based retrieval. For example, the semantic advertisement index 416 may store embeddings of machine-readable digital advertisements and metadata (e.g., creative text, landing URL, region, compliance tags, payout schema, etc.). In an embodiment, the semantic advertisement index 416 operates as an indexed data structure that maps content objects to one or more vector representations and associated metadata attributes, which enables low-latency identification of content objects relevant to a given context representation.

The digital advertising engine 408 may be embodied as any hardware, software, and/or circuitry for an AI/ML-based generational model configured to generate machine-produced output and to coordinate insertion of supplemental content into a streaming sequence of tokens during generation and detect commercial intent in a user input. The tokens can include control tokens, such as a reserved pair of zero-width control tokens (e.g., ‘<s_ad_start>’ and ‘<s_ad_end>’) that the digital advertising engine 408 can inject during text generation to delimit sponsored segments. Tokens may be obtained via various sources. For example, tokens may be drawn from Unicode Private-Use Area or implemented as out-of-band tags in a parallel metadata channel (so as to not appear to a user of a given client device 112). Tokens may also be nestable within higher-level JSON ‘tool’ messages for model that support structured output.

The streaming gateway 410 may be embodied as any hardware, software, and/or circuitry configured to transmit emitted tokens to a given client device 112. The streaming gateway 410 may be further configured to remove or escape control tokens. The renderer component 412 may be embodied as any hardware, software, and/or circuitry configured to render a token stream into a natural language string. In doing so, the renderer component 412 may receive offset map 420 data and styling rules (e.g., background color, “Sponsored” pill, aria-described by, etc.). The offset map 420 generally corresponds to a client-agnostic metadata map that transmits byte or UTF-16 offsets of tokens to enable the renderer component 412 to locate and style the sponsored span after token stripping. In an embodiment, the renderer component 412 may reference a disclosure-style manifest that recommends visual treatments (e.g., label text, shading, aria-labels) but leaves them overridable to ensure that each host application (e.g., mobile application 115) can meet locale-specific regulations. The compliance component 414 may be embodied as any hardware, software, and/or circuitry configured to log (e.g., in compliance logging 418) the rendered disclosure style and token positions to create an auditable record for regulatory bodies.

Note, although FIG. 4 illustrates each component as being part of the AI agent application 110, one of skill in the art will recognize that the components may be distributed across different systems and processes. For example, individual components may reside on-device (e.g., the client device 112) or on the cloud platform 102. Doing so reduces potential for leakage of personally identifiable information (PII).

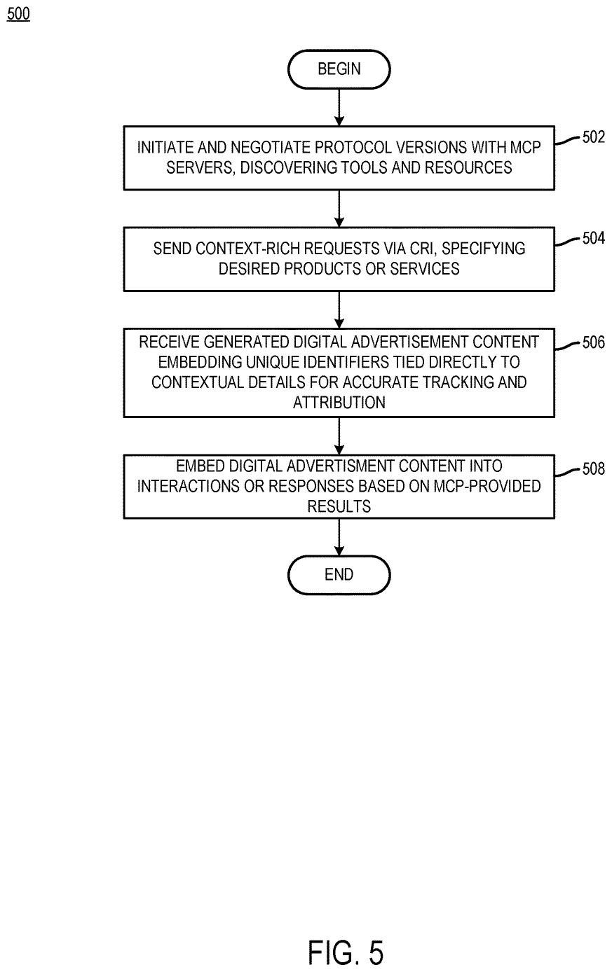

Referring now to FIG. 5, the AI agent device 108, in operation, may perform a method 500 for delivering contextually relevant recommendations in response to a real-time context and/or interaction. As shown, the method 500 begins in block 502, in which the AI agent device 108 initiates communication with the MCP server 104 and performs a protocol negotiation procedure to establish a compatible communication configuration. In an embodiment, the protocol negotiation procedure includes a multi-step handshake in which the AI agent device 108 and the MCP server 104 exchange capability data and determine a mutually supported protocol version and feature set. In an embodiment, the AI agent device 108 transmits an initialization message to the MCP server 104. The initialization message may include a list of supported protocol versions, supported transport mechanisms (e.g., JSON-RPC over HTTP, WebSocket, Server-Sent Events (SSE)), and the like. The initialization message may further include identifiers associated with the requesting component and session metadata. Once initialized, the AI agent device 108 may perform discovery of available tools and resources thereto. The response from the MCP server 104 may indicate supported transports (e.g., MCP, REST, GraphQL), authentication methods, and schema versions. In turn, the AI agent device 108 may select the best path given capabilities of underlying AI/ML models. For instance, the AI agent device 108 may select a communication and processing path based on the negotiated protocol parameters and capabilities of the AI/ML models based on a set of candidate execution paths, in which each path corresponds to a combination of a transport mechanism, a message format, and an invocation mode supported by the AI/ML model.

In operation, the AI agent device 108 may receive inputs from a user (e.g., via an application executing on the client device 112 such as the web browser 114 and the mobile application 115. The AI agent device 108 may formulate, from the user inputs, structured queries via the contextual request interface 302 exposed by the MCP server 104.

In block 504, the AI agent device 108 transmits the structured requests to the MCP server 104 using the communication configuration established during the protocol negotiation procedure. In an embodiment, AI agent device 108 serializes the structured request into a message format corresponding to the selected protocol version and transport mechanism and transmits the request over an established communication channel.

In block 506, the MCP server 104 processes the structured request and generates one or more content objects responsive to the contextual data contained therein. In an embodiment, the MCP server 104 executes a content construction pipeline that transforms the structured request into a transmission-ready content object suitable for integration into a generated output. For example, the MCP server 104 may generate an affiliate link embedding a unique identifier tied directly to contextual details for accurate tracking and attribution.

In block 508, the AI agent application 108 embeds the digital advertisement into an interaction (e.g., as a text response to the user input). In an embodiment, the AI agent application 108 performs the embedding during generation of the token sequence, such that the content object is incorporated into the output without requiring post-generation rewriting of the sequence. Examples for the digital advertisement generation, retrieval, and embedding are provided further herein. The MCP server 104 may automatically record user interactions, track conversions, and calculate and distribute revenues.

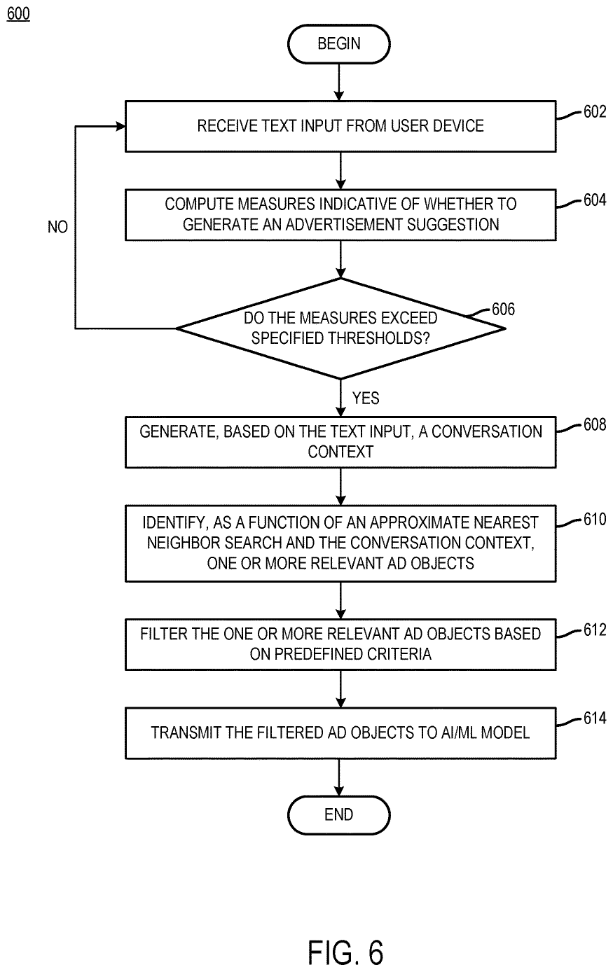

Referring now to FIG. 6, the AI agent device 108, in operation, may perform a method 600 for dynamically retrieving semantic content in response to a user input. As shown, the method 600 begins in block 602, in which the AI agent device 108 receives a text input from a user device (e.g., the client device 112). For instance, AI agent device 108 may receive the input via an interface associated with an application executing on the client device 112, such as a web browser, messaging interface, or application programming interface. In block 604, the AI agent device 108 computes measures (e.g., intent scores) indicative of whether to incorporate supplemental content into a generated output (e.g., whether to generate an advertisement suggestion or recommendation for rendering on a display of the client device 112). For instance, the AI agent device 108 may evaluate the input and associated context to generate one or more scores that reflect characteristics such as intent, relevance, or contextual suitability.

In block 606, the AI agent device 108 determines whether the measures exceed specified thresholds (or threshold conditions). Particularly, the AI agent device 108 may evaluate the measures generated in block 604 against predefined or dynamically determined thresholds to produce a decision signal (or other indicator) that governs subsequent processing. If not, then the method 600 returns to block 602. Otherwise, in block 608, the AI agent device 108 generates, based on the text input, a conversation context and a vector representation of the text input. A conversation context may correspond to a structured representation of information associated with an input and one or more related interactions. The conversation context can include data corresponding to a current input (e.g., a text input), as well as additional contextual information such as prior inputs, prior outputs, session-level data, user-specific attributes, environmental conditions, system-generated metadata, and the like. The vector representation of the text input may correspond to a numerical representation of input data in a multi-dimensional space, where values of the representation encode one or more characteristics of the input. In an embodiment, the AI agent device 108 may generate the vector representation by transforming the text input, and optionally associated contextual data, into a sequence or set of numerical values that can be processed by computational systems. In an embodiment, the vector representation may be generated using a model configured to map input data into a feature space in which distances or similarities between vectors correspond to relationships between inputs. The AI agent device 108 transforms the input and associated contextual data into one or more structured representations that capture semantic and contextual characteristics of the input.

In block 610, the AI agent device 108 identifies, as a function of a similarity search (e.g., an approximate nearest neighbor search using the vector as input), one or more relevant ad objects. For instance, to do so, the AI agent device 108 may perform a query processing operation in which the vector representation generated in block 608 is used to retrieve candidate content objects from a data store, such as the semantic advertisement index 416. In block 612, the AI agent device 108 filters the relevant ad objects based on a predefined criteria. For example, the AI agent device 108 may evaluate attributes associated with each candidate content object and selectively removes or retains objects to produce a filtered candidate set for subsequent processing. In block 614, the AI agent device 108 may provide the filtered as input for use as input to an AI/ML model for generating a natural language response that incorporates the ad object therein.

For instance, as a practical example, a conversational context may be embedded via a known model, such as the OpenAI text-embedding-3-large model, which yields a 768-dimensional float32 vector. An HNSW index (M=64, efConstruction=200) having approximately 50,000 ad objects returns the top five matches in 86 ms on an 8-core x86-64 CPU, which advantageously demonstrates an improvement over prior art approaches in computing performance.

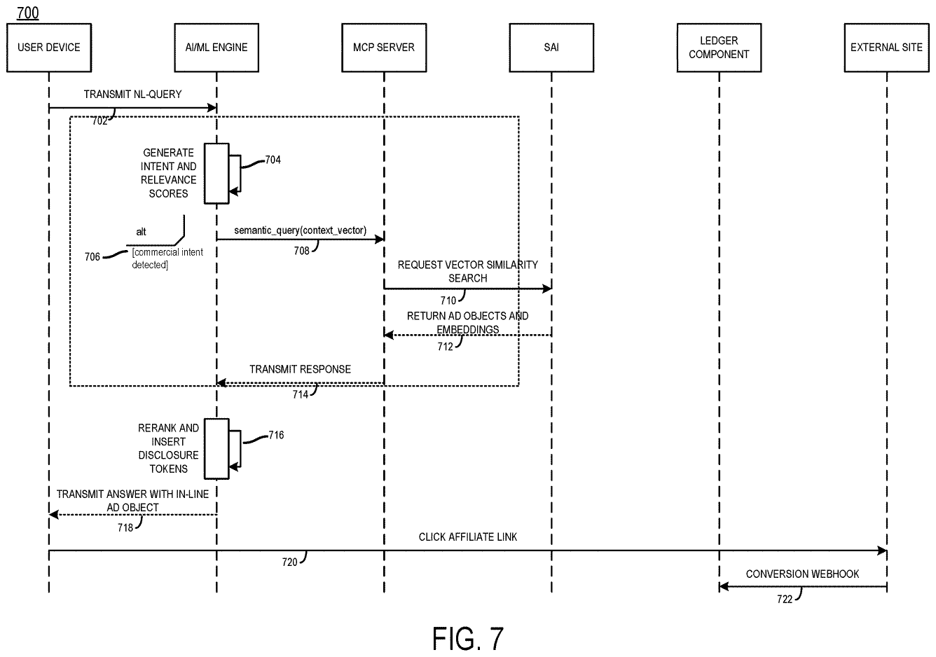

Referring now to FIG. 7, a sequence 700 depicting an example for delivering contextually relevant recommendations (in this example, an affiliate link) in response to a real-time context and/or user interaction is shown. Particularly, the sequence 700 depicts sequence interactions between the user device (e.g., client device 112), LLM-based AI/ML engine (e.g., the digital advertising engine 408 executing on an AI agent device 108), MCP server (e.g., MCP server 104), semantic advertising index (semantic advertising index 416), ledger component (e.g., ledger component 406), and an external website (e.g., a merchant website).

The sequence 700 may be triggered in response to the user device transmitting an input. In 702, the user device transmits a natural language query to the AI/ML engine. In 704, the AI/ML engine generates intent and relevance scores indicative of whether the natural language query is likely to represent a commercial intent (i.e., serving a digital advertisement to the user is warranted).

If the intent and relevance scores exceed a specified threshold, then the sequence 700 enters a conditional in 706 (comprising 708-716) indicating that a commercial intent has been detected. In 708, the AI/ML creates a structured query using, as input, a generated dense context vector of the natural language query and transmits the context vector to the MCP server via a specified transport. The query vector may include information such as a vector position, timestamp, agent identifier, and locale. In 710, the MCP server uses the context vector in a similarity search in the semantic advertisement index. The similarity search can be, for example, an approximate nearest neighbor (ANN) search to identify the most relevant ad(s) as well as achieve low latency efficiency (i.e., ANN plus vector caching potentially delivers sub-100 ms ad retrievals, even at scale). Example ANN algorithms that may be used include HNSW, FAISS, and the like. In 712, the semantic advertisement index returns, based on the similarity search, ad objects and embeddings. In 714, the MCP server returns the response including the ad objects and embeddings to the AI/ML engine. In 716, the AI/ML engine may rerank the ad objects and insert disclosure tokens in formulating a response to transmit to the user. In doing so, the AI/ML engine applies campaign targeting rules (e.g., geography, device, budget, etc.). In 718, the AI/ML engine transmits, to the user device, the formulated response. In 720, the user device sends an indication to the external site that the affiliate link has been clicked. In 722, the external site transmits a conversion webhook to the ledger component.

Advantageously, the system decouples ad-retrieval logic from the runtime of the AI/ML model to ensure that the semantic-query primitive can be invoked over multiple transport layers. To that end, the system supports multiple integration modes. For example, the system may incorporate MCP-Embedded Tooling, which supports structured tool calls (e.g., via LangChain's Tool, OpenAI function calling over stdio/SSE, or local llama. cpp JSON) and emits a ‘semantic_query’ JSON-RPC request mid-generation. The request traverses the MCP transport and returns objects in-band, thus allowing the model to weave the ad into the completion token stream with token-level disclosure markers. As another example, the system may incorporate Pure HTTP API, a function-call style in which cloud models such as Open AI GPT-4o, Anthropic Claude, Google Gemini, and the like can reach the same ‘/semantic_query’ endpoint over HTTPS. The orchestrator registers the function schema, and the model determines when to call the function. The JSON response is spliced back into the tool-response channel of the model and surface to the user inline. As yet another example, the system may incorporate POST-Generation REST Hook for models that cannot issue tool calls. Particularly, middleware can insert a placeholder tag (e.g., ‘{{AD_SLOT}}’) into a given prompt. After the model produces a given plain-text answer, the middleware detects the tag, calls ‘/semantic_query’, and patches the returned ad into the response before delivery, and disclosure styling is handled client-side (e.g., using offset metadata). Regardless of the integration mode used, the underlying model ultimately obtains the same structured ad object and disclosure offsets, ensuring consistent compliance and analytics.

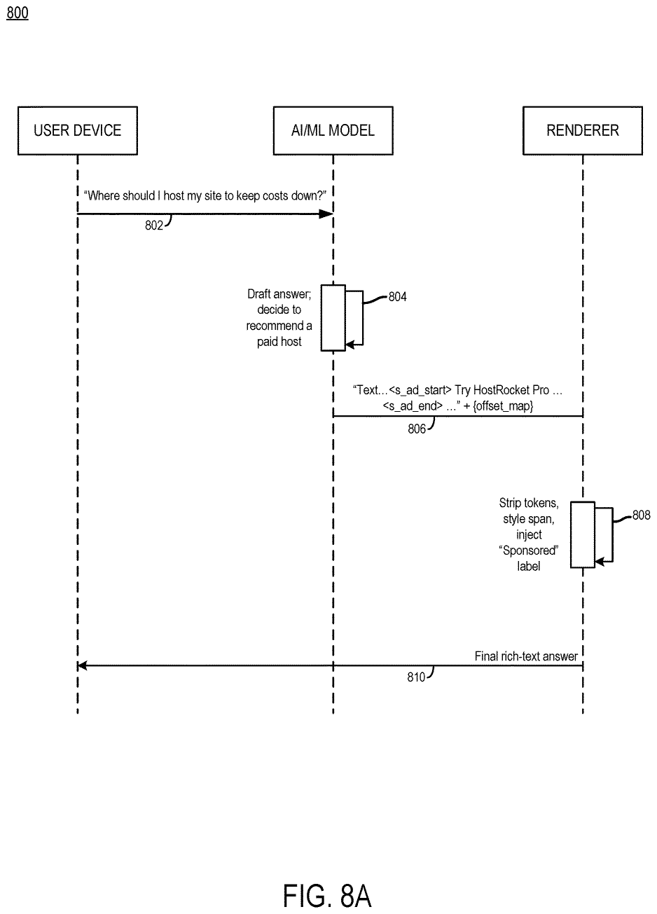

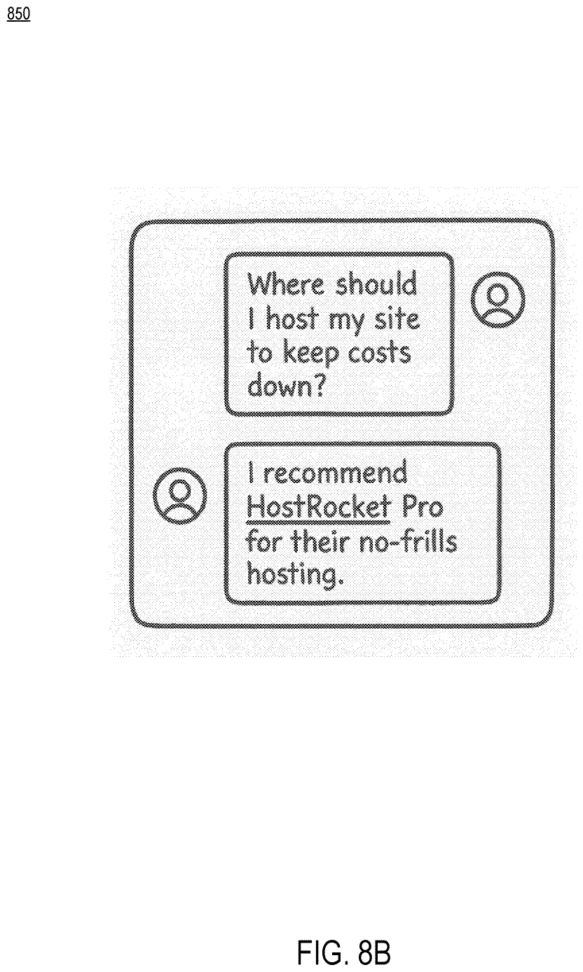

FIGS. 8A and 8B provide another example of the disclosed technology in use, as applied towards a digital advertisement embedded into a chatbot reply. FIG. 8A illustrates a sequence 800 in which a user device transmits, in 802, to the AI/ML model a text string “Where should I host my site to keep costs down?” In 804, the AI/ML model drafts an answer and decides to recommend a paid host. During generation, the AI/ML model inserts reserved disclosure tokens (e.g., <s_ad_start> . . . <s_ad_end>) that are never shown to the user. In 806, the AI/ML model transmits a raw response stream “Text . . . <s_ad_start> I recommend HostRocket Pro for their no-frills hosting <s_ad_end> . . . ” +{offset_map} to the renderer for formatting. In 808, the renderer formats the response, e.g., by stripping tokens, performing a style span, and embedding a “Sponsored” label indicator to the response. Particularly, the renderer receives the stream, detects boundaries via ad_disclosure, and applies a distinct style (e.g., shading, “Sponsored”, etc.) without moving the ad outside the paragraph to preserve readability and compliance. In 810, the renderer returns a response indicative of a final rich-text answer. FIG. 8B illustrates a chat box user interface 850 depicting the exchange as displayed on the user device. Illustratively, the user interface 850 shows the digital advertisement response with an affiliate link embedded into the response.

Advantageously, by using true semantic matching (rather than keyword rules and matching), higher clickthrough rate and accuracy of more relevant ads can be achieved. Further, the disclosed technology allows any ad-retrieval engine (or even hard-coded promotions) to supply creative text in part due to the UI substrate that keeps the digital advertisement in-situ while making disclosure conspicuous. Further, in the practical example discussed above relative to FIG. 6, the token stream of FIG. 8A <s_ad_start> and <s_ad_end> occur at UTF-16 indices 128 and 173, respectively. The disclosure label is rendered with at least a 3% luminance-contrast ratio.

While the foregoing is directed to embodiments of the present disclosure, other and further embodiments of the disclosure may be devised without departing from the basic scope thereof, and the scope thereof may be determined by the example claims that follow.

### EXAMPLES

Illustrative examples of the technologies disclosed herein are provided below. An embodiment of the technologies may include any one or more, and any combination of, the examples described below.
Example 1 includes a computer-implemented method comprising receiving, from a generative language model, a streaming sequence of natural-language tokens further comprising a first and a second zero-width control token that respectively mark a start and an end of a sponsored segment; constructing, by the one or more processors and in real time, an offset map that specifies indices delimiting the sponsored segment; causing, by the one or more processors, a client device to render the natural-language tokens while programmatically applying a visual treatment to the sponsored segment according to the offset map; and causing, by the one or more processors, the client device to present, adjacent to the sponsored segment, a disclosure label having a luminance-contrast ratio of relative to non-sponsored text.
Example 2 includes the subject matter of Example 1, and wherein the first and second zero-width control tokens are selected from a reserved token space not rendered in the natural-language output.
Example 3 includes the subject matter of any of Examples 1 and 2, and wherein constructing the offset map comprises determining starting and ending UTF-16 indices corresponding to the sponsored segment within the streaming sequence of natural-language tokens.
Example 4 includes the subject matter of any of Examples 1-3, and wherein the visual treatment is applied in real time as tokens are rendered.
Example 5 includes the subject matter of any of Examples 1-4, and wherein the visual treatment preserves a position of the sponsored segment within the natural-language tokens without reordering tokens.
Example 6 includes the subject matter of any of Examples 1-5, and wherein the sponsored segment corresponds to content inserted during generation of the streaming sequence of natural-language tokens.
Example 7 includes the subject matter of any of Examples 1-6, and wherein the disclosure label is positioned adjacent to the sponsored segment without separating the sponsored segment from surrounding natural-language content.
Example 8 includes a computer-implemented method, comprising receiving, from a client device, a natural language input; determining, using a machine learning-based model, whether the natural language input is indicative of a commercial intent; upon a determination that the natural language input is indicative of the commercial intent, generating, using the machine learning-based model, a context vector representation of the natural language input, and identifying one or more ad objects based on a similarity search using the context vector representation over a semantic advertisement index; generating a streaming sequence of tokens representing a natural language response; during generation of the streaming sequence of tokens inserting a first control token and a second control token delimiting a segment corresponding to at least one of the ad objects, and emitting tokens corresponding to the at least one ad object between the first and second control tokens; and transmitting the streaming sequence of tokens to the client device for display thereon.
Example 9 includes the subject matter of Example 8, and further including generating metadata including offset information corresponding to the segment, wherein transmitting the streaming sequence of tokens further comprises transmitting the streaming sequence of tokens and the metadata to the client device.
Example 10 includes the subject matter of any of Examples 8 and 9, and wherein the metadata comprises UTF-16 positional offsets.
Example 11 includes the subject matter of any of Examples 8-10, and wherein identifying the one or more ad objects comprises performing an approximate nearest neighbor search.
Example 12 includes the subject matter of any of Examples 8-11, and wherein the vector representation comprises a high-dimensional embedding of a conversation context.
Example 13 includes the subject matter of any of Examples 8-12, and further including generating a disclosure label for rendering on the client device.
Example 14 includes the subject matter of any of Examples 8-13, and wherein the ad object comprises a compliance tag indicating a regulatory jurisdiction.
Example 15 includes a system, comprising one or more processors; a memory storing program code, which, when executed on the one or more processors, causes the system to receive, from a client device, a natural language input; determine, using a machine learning-based model, whether the natural language input is indicative of a commercial intent; upon a determination that the natural language input is indicative of the commercial intent, generate, using the machine learning-based model, a context vector representation of the natural language input, and identifying one or more ad objects based on a similarity search using the context vector representation over a semantic advertisement index; generate a streaming sequence of tokens representing a natural language response; during generation of the streaming sequence of tokens insert a first control token and a second control token delimiting a segment corresponding to at least one of the ad objects, and emit tokens corresponding to the at least one ad object between the first and second control tokens; and transmit the streaming sequence of tokens to the client device for display thereon.
Example 16 includes the subject matter of Example 15, and wherein at least one of the tokens in the streaming sequence are selected from a reserved token space not rendered in the natural-language output, and wherein the plurality of instructions further causes the system to construct an offset map by determining starting and ending UTF-16 indices corresponding to a sponsored segment within the streaming sequence of tokens.
Example 17 includes the subject matter of any of Examples 15 and 16, and wherein the sponsored segment corresponds to content inserted during generation of the streaming sequence of natural-language tokens.
Example 18 includes the subject matter of any of Examples 15-17, and wherein the plurality of instructions further causes the system to cause the client device to apply a visual treatment in real time as tokens are rendered.
Example 19 includes the subject matter of any of Examples 15-18, and wherein the visual treatment preserves a position of a sponsored segment within the sequence of tokens without reordering the tokens.
Example 20 includes the subject matter of any of Examples 15-19, and wherein a disclosure label is positioned adjacent to the sponsored segment without separating the sponsored segment from surrounding natural-language content.

1. A computer-implemented method comprising:
receiving, from a generative language model, a streaming sequence of natural-language tokens further comprising a first and a second zero-width control token that respectively mark a start and an end of a sponsored segment;
constructing, by the one or more processors and in real time, an offset map that specifies indices delimiting the sponsored segment;
causing, by the one or more processors, a client device to render the natural-language tokens while programmatically applying a visual treatment to the sponsored segment according to the offset map; and
causing, by the one or more processors, the client device to present, adjacent to the sponsored segment, a disclosure label having a luminance-contrast ratio of relative to non-sponsored text.

2. The computer-implemented method of claim 1, wherein the first and second zero-width control tokens are selected from a reserved token space not rendered in the natural-language output.

3. The computer-implemented method of claim 1, wherein constructing the offset map comprises determining starting and ending UTF-16 indices corresponding to the sponsored segment within the streaming sequence of natural-language tokens.

4. The computer-implemented method of claim 1, wherein the visual treatment is applied in real time as tokens are rendered.

5. The computer-implemented method of claim 1, wherein the visual treatment preserves a position of the sponsored segment within the natural-language tokens without reordering tokens.

6. The computer-implemented method of claim 1, wherein the sponsored segment corresponds to content inserted during generation of the streaming sequence of natural-language tokens.

7. The computer-implemented method of claim 1, wherein the disclosure label is positioned adjacent to the sponsored segment without separating the sponsored segment from surrounding natural-language content.

8. A computer-implemented method, comprising:
receiving, from a client device, a natural language input;
determining, using a machine learning-based model, whether the natural language input is indicative of a commercial intent;
upon a determination that the natural language input is indicative of the commercial intent, generating, using the machine learning-based model, a context vector representation of the natural language input, and identifying one or more ad objects based on a similarity search using the context vector representation over a semantic advertisement index;
generating a streaming sequence of tokens representing a natural language response;
during generation of the streaming sequence of tokens:
inserting a first control token and a second control token delimiting a segment corresponding to at least one of the ad objects, and
emitting tokens corresponding to the at least one ad object between the first and second control tokens; and
transmitting the streaming sequence of tokens to the client device for display thereon.

9. The computer-implemented method of claim 8, further comprising:
generating metadata including offset information corresponding to the segment, wherein transmitting the streaming sequence of tokens further comprises transmitting the streaming sequence of tokens and the metadata to the client device.

10. The computer-implemented method of claim 9, wherein the metadata comprises UTF-16 positional offsets.

11. The computer-implemented method of claim 8, wherein identifying the one or more ad objects comprises performing an approximate nearest neighbor search.

12. The computer-implemented method of claim 8, wherein the vector representation comprises a high-dimensional embedding of a conversation context.

13. The computer-implemented method of claim 8, further comprising generating a disclosure label for rendering on the client device.

14. The method of claim 8, wherein the ad object comprises a compliance tag indicating a regulatory jurisdiction.

15. A system, comprising:
one or more processors;
a memory storing program code, which, when executed on the one or more processors, causes the system to:
receive, from a client device, a natural language input;
determine, using a machine learning-based model, whether the natural language input is indicative of a commercial intent;
upon a determination that the natural language input is indicative of the commercial intent, generate, using the machine learning-based model, a context vector representation of the natural language input, and identifying one or more ad objects based on a similarity search using the context vector representation over a semantic advertisement index;
generate a streaming sequence of tokens representing a natural language response;
during generation of the streaming sequence of tokens:
insert a first control token and a second control token delimiting a segment corresponding to at least one of the ad objects, and
emit tokens corresponding to the at least one ad object between the first and second control tokens; and
transmit the streaming sequence of tokens to the client device for display thereon.

16. The system of claim 15, wherein at least one of the tokens in the streaming sequence are selected from a reserved token space not rendered in the natural-language output, and wherein the plurality of instructions further causes the system to construct an offset map by determining starting and ending UTF-16 indices corresponding to a sponsored segment within the streaming sequence of tokens.

17. The system of claim 16, wherein the sponsored segment corresponds to content inserted during generation of the streaming sequence of natural-language tokens.

18. The system of claim 15, wherein the plurality of instructions further causes the system to cause the client device to apply a visual treatment in real time as tokens are rendered.

19. The system of claim 18, wherein the visual treatment preserves a position of a sponsored segment within the sequence of tokens without reordering the tokens.

20. The system of claim 19, wherein a disclosure label is positioned adjacent to the sponsored segment without separating the sponsored segment from surrounding natural-language content.
